(19) United States
(12) Patent Application Publication
(10) Pub. No.: US 2003/0230455 A1
(43) Pub. Date: Dec. 18, 2003

(54) Ladder or stackable ladder with a ladder leveler, and a leveler for ladders, and a method of using a leveler for ladders

(76) Inventor: Timothy D. Armstrong, Youngwood, PA (US)

Correspondence Address: NILS H. LJUNGMAN, NILS H. LJUNGMAN & ASSOCIATES, P.O. BOX 130, GREENSBURG, PA, 15601, US

(21) Appl. No.: 10/387,258

(22) Filed: Mar. 12, 2003

Related U.S. Application Data
(60) Provisional application No. 60/363,644, filed on Mar. 12, 2002.

(51) Int. Cl. E06C 7/00

(52) U.S. Cl. 182/204

(57) ABSTRACT

An integrated, non-articulated ladder leveler for leveling ladders and stackable ladders and a ladder or stackable ladder with at least one leveling device installed. The leveler includes a rectangular shaft that fits into the ladder rail, a ladder foot designed to match the other foot of the ladder, and a pin to hold the ladder leveler in place while in use or while closed. The leveler is designed to allow the user to use the ladder or stackable ladder on an uneven surface and without compromising the function of stackability.

### RELATED APPLICATION DATA

This application claims the benefit under 35 U.S.C. §120 of copending U.S. Provisional Patent Application No. 60/363,644, filed on Mar. 12, 2002, having inventor Timothy D. Armstrong, and being entitled “Stackable ladders with a ladder leveler; leveler for stackable ladders.”

### BACKGROUND OF THE INVENTION

1. Field of the Invention

This invention relates to a ladder and a device for leveling ladders. More specifically, this invention is designed to allow safer ladder usage on uneven surfaces. It provides an easy means for extending one ladder leg to compensate for the unevenness.

2. Background Information

Ladder use, unfortunately, often does not take place on completely level surfaces. Necessity dictates that ladders be used in a variety of situations and settings. For the safety of the user, it is quite advantageous to have a means to level the ladder. This is especially true of stackable and sectional ladders, where additional height may provide added danger. As height increases, the risk of overbalancing on an uneven ladder also increases. The risk of injury due to fall also rises with height attained.

Attempts have been made to produce ladder leveling devices. These are typically designed for standard ladders. When used with stackable ladders, the function of stacking is often compromised. This is because stackable ladders have specially designed feet which secure themselves to the ladder below. Levelers designed to mimic conventional flat ladder feet often cannot be safely stacked.

Other ladder levelers, especially add-on devices, can be very bulky and heavy. Because these levelers protrude on the outside surfaces of the ladder itself, they provide an increased risk of getting caught on other structures. This can be quite dangerous, especially at the previously mentioned heights. Blocks and shims are cumbersome to transport and are not very secure. They may move while the ladder is being used.

A ladder leveler which is difficult to operate would be quite impractical. The best position to pull or push such a device would be to have it in front of the operator. Given the length of a ladder, situating it horizontally would require more space than what may be available. It would also probably require the user to take the ladder down from its current position. Ladders are heavy and not easily moved around in such a manner. It would be advantageous to be able to somehow level the leg or readjust the leg while the ladder is still in the position of desired use. Therefore, a secure, self-contained, integrated device which does not require additional space for transport would prove to be most convenient and safe.

### OBJECT OF THE INVENTION

The present invention has been conceived out of the need for a self-contained, safe, and convenient means to level a ladder or stackable ladders which allows the user to extend a ladder leg to compensate for uneven terrain without compromising the function of stackability. While it is designed for certain stackable and sectional type ladders, it can be adjusted to fit within several different sizes of similar types of ladders through minor size and parameter changes.

### SUMMARY OF THE INVENTION

An embodiment of the invention is an integrated leveling device or leveling leg designed specifically for ladders and stackable or sectional type ladders. This makes the ladders safer to use without sacrificing stackability or convenience of storage. This embodiment is constructed out of metal alloy. It comprises a rectangular shaft and a ladder foot. The rectangular shaft is sized to fit inside the rail of the ladder and move inside the rail for adjustment. The shaft preferably has a plurality of holes drilled completely through from the front to the back. Once the device is moved to the desired position, the hole in the shaft is lined up with the hole drilled in the ladder rail. The Quick Release Pin is inserted to lock the leveling leg in position.

After the leveling leg is adjusted into the desired position, it may become necessary to readjust the leveling leg during use. Upon removal of the pin, however, there exists the possibility that the leveling leg could slide out of the ladder leg, thus complicating the use of the leveling leg as well as possibly decreasing safety on the work site. To prevent this, in an additional embodiment, a separate insert can be inserted in a secure friction fit inside the ladder leg. The insert can be tapered to increase the strength of the friction fit and compensate for manufacturing tolerances. The insert functions to strengthen the ladder leg at the point of connection with the shaft of the leveling leg. The insert also functions to retain the leveling leg portion in the ladder leg to prevent the leveling leg from falling out.

To further explain, prior to pressing the insert into the ladder leg, the shaft of the leveling leg is pushed through the insert. A retaining flange or piece is then attached to the end of the shaft opposite the foot end and on the other side of the insert. The retaining flange is secured by screws, adhesive, or a weld to the shaft. The retaining flange extends out past the edge or edges of the shaft. The retaining flange is designed to fit inside the ladder leg, so its dimensions cannot exceed the interior dimensions of the ladder leg.

After securing the retaining flange, the insert is pressed into the ladder leg. In this manner, the shaft may now slide back and forth through the insert in the ladder leg. The insert has a hole which is lined up with the hole in the ladder leg to permit insertion of the pin to secure the leveling leg. In this embodiment, if the pin is removed while the ladder is in a vertical position, the leveling leg can slide down until the retaining flange contacts the insert. In this manner, the leveling leg cannot slide completely out of the ladder leg and can be simply slid back into a desired position and secured with the pin.

In one embodiment, the foot of the device is structured to the actual shape and size of the original ladder feet, such as flat or rounded ladder feet as well as the curved, substantially C-shaped feet of a stackable ladder. Because the foot shape of the insert is the substantially similar to the other foot of the ladder, a stackable ladder, for example, with the device installed can still function as a stackable middle section. This particular design also allows the foot to function as a ground spike, adding to the ladder stability.

The foot of the device can also be made to adjust to other types of feet or pads so that the ladder may be used on different surfaces. One such possibility is the molded rubber grip foot. When used, it is attached to bottom of the device for surfaces requiring better grip, namely, concrete or smooth tile. An embodiment of the rubber foot is held in place by rubber nibs which fit into mounting holes on the device. This embodiment is operated in a substantially identical fashion to the previously mentioned one. In another embodiment, the rubber grip foot is held in place with two screws and two washers which are inserted into the mounting holes.

An embodiment of the invention contains a spring-loaded mechanism. It consists of three parts: 1) the Bandspring 2) the Guide Stop Pin and 3) the Bandspring Stop Plate. One end of the bandspring is attached to the top of the device and the other is attached to the bottom side of the Bandspring Stop Plate. The mechanism is inserted into the ladder rail until the Bandspring Stop Plate reaches and cradles the portion of the bottom ladder rung which extends inside the rail. The rung acts as a platform for spring compression. Once inside the rail, the device is secured with the Guide Stop Pin, which is inserted into the hole in the top of the device through a channel cut into the rail. The bottom of the channel will act as a catch for the Guide Stop Pin, thereby preventing the device from falling out of the ladder rail. The spring-loaded design allows the device to automatically extend itself to the proper length without requiring the user to pull it down from an awkward position, or move the ladder to adjust it more easily.

The embodiments' simplicity of design makes the device easily operated and stored. Since the device is concealed within the ladder rail, storage area required for the ladder is not affected. When stored, the leveler is compressed to its closed position, and the Detent Ring Pin is inserted to keep it in place. Because it is concealed within the ladder, the leveler is virtually hidden from sight and leaves no hazards upon which to catch self or clothing. Also, when closed, it has virtually no effect on the size or outward appearance of the ladder.

The above-discussed embodiments of the present invention will be described further hereinbelow. When the word “invention” is used in this specification, the word “invention” includes “inventions”, that is the plural of “invention”. By stating “invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The attached drawings illustrate at least one embodiment of the invention described above.

FIG. 1 illustrates a front view of an embodiment of the invention;

FIG. 2 illustrates a side view of the embodiment shown in FIG. 1;

FIG. 3 illustrates a top view of the embodiment shown in FIG. 1;

FIG. 4 illustrates a bottom view of the embodiment shown in FIG. 1;

FIG. 5 illustrates the embodiment shown in FIG. 1 in relation to a stackable ladder with which it could be used;

FIG. 6 illustrates a possible use of an embodiment of the invention;

FIG. 7 illustrates a view of another possible embodiment, this one with a rubber grip foot;

FIG. 8 illustrates the assembly of the embodiment shown in FIG. 7, which attached to the body using rubber nibs;

FIG. 9 illustrates a view of another possible embodiment of the invention discussed above, which utilizes a spring-loaded mechanism;

FIG. 10 illustrates the parts which make up the embodiment shown in FIG. 9;

FIG. 11 illustrates how the embodiment shown in FIG. 9 is assembled;

FIG. 12 illustrates a cut-away view inside the ladder rail of the embodiment shown in FIG. 9 when in its closed position;

FIG. 13 illustrates a disassembled view of another possible embodiment of the invention discussed above;

FIG. 14 illustrates an assembled view of the embodiment shown in FIG. 13;

FIG. 15 illustrates a bottom assembled view of the embodiment shown in FIG. 13;

FIG. 16 illustrates a side disassembled view of the embodiment shown in FIG. 13;

FIG. 17 shows a ladder leg and the metal insert;

FIG. 18 shows the ladder leg and insert shown in FIG. 17 with the leveler leveler leg and retaining clip;

FIG. 19 shows a frontal view of the leveler leg in use on a ladder that is standing on a flight of stairs;

FIG. 20 shows a frontal view of the leveler leg in use on a ladder that is standing on a flight of stairs;

FIG. 21 shows a side perspective view of the leveler leg in use on a ladder that is standing on a flight of stairs;

FIG. 22 is shows a frontal view of the leveler leg being used on the sloped surface of a roof;

FIG. 23 shows a side perspective of the leveler leg shown in FIG. 22;

FIG. 24 shows the leveler leg being applied for use on uneven or sloped ground;

FIG. 25 shows a close-up, partial view of an embodiment of the invention being used in a stackable ladder arrangement;

FIG. 26 shows a distant, full view of the embodiment shown in FIG. 25;

FIG. 27 shows a perspective view of the leveler leg lying flat on the ground;

FIG. 28 shows the leveler leg disassembled and laying next to the ladder rail from which it has been removed and the quick release pin; and

FIG. 29 shows the leveler leg and the quick release pin lying flat on the ground.

### DESCRIPTION OF THE PREFERRED EMBODIMENT

It is to be noted that all measurements shown in the drawings are provided for purposes of example and to show at least one possible embodiment of the present invention. It should be understood that the present invention or possible embodiments thereof are not limited to these measurements. It is within the scope of the invention to use different sizes and measurements for the different components of the present invention.

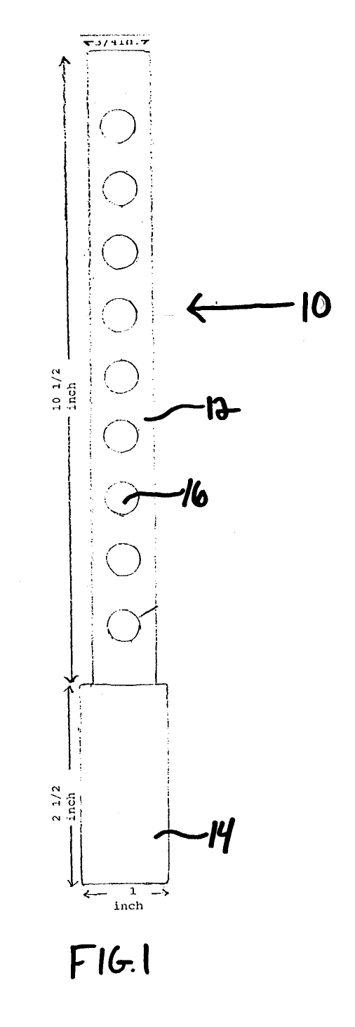

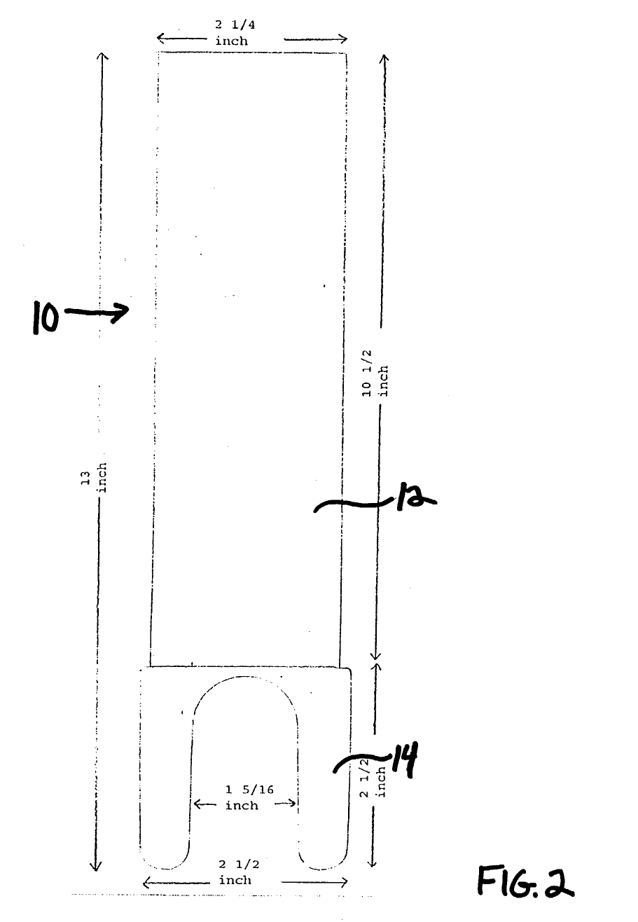

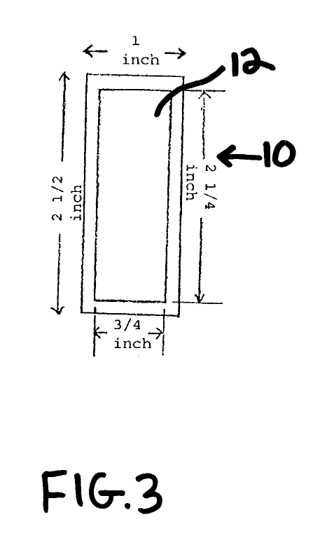

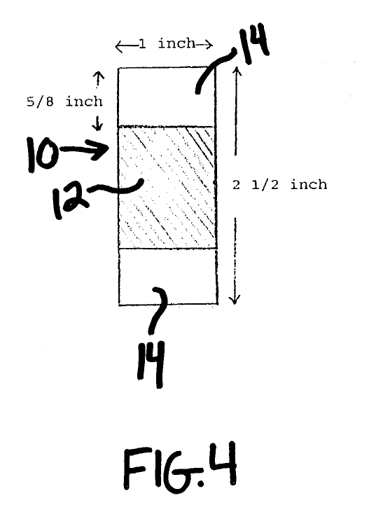

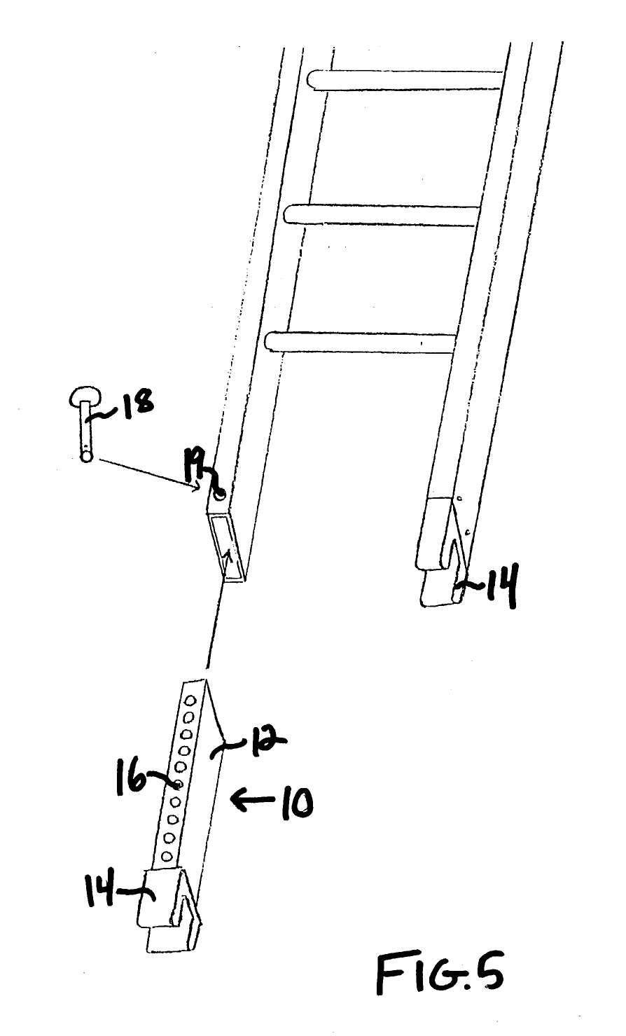

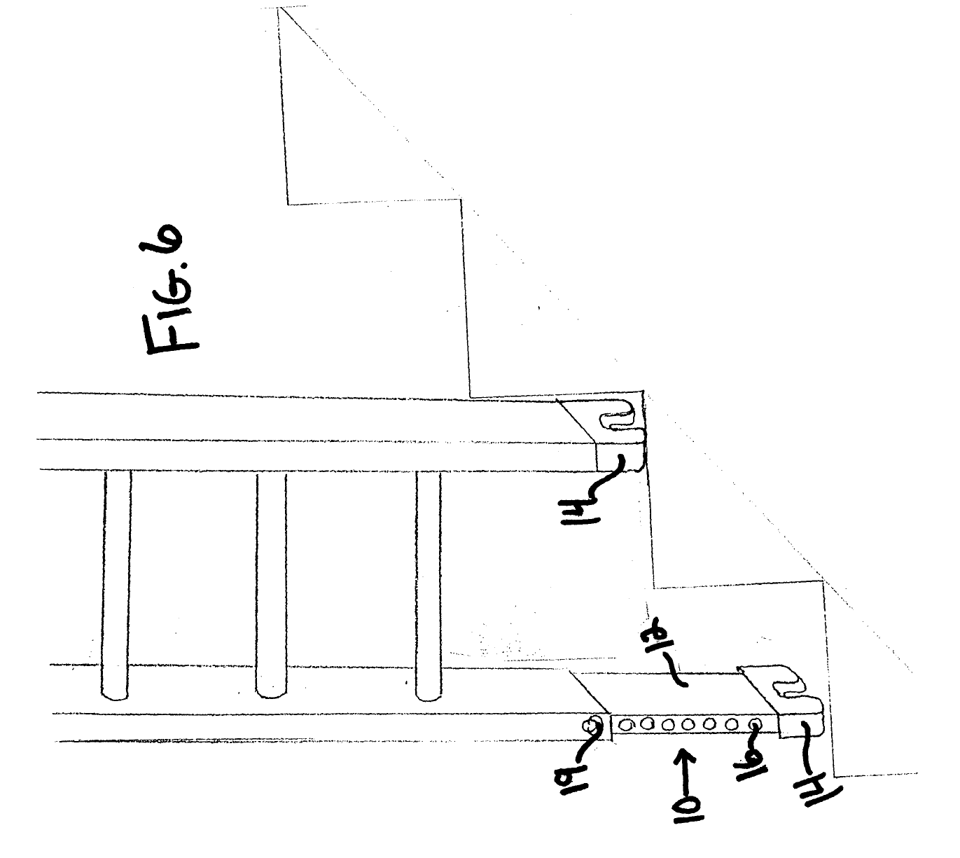

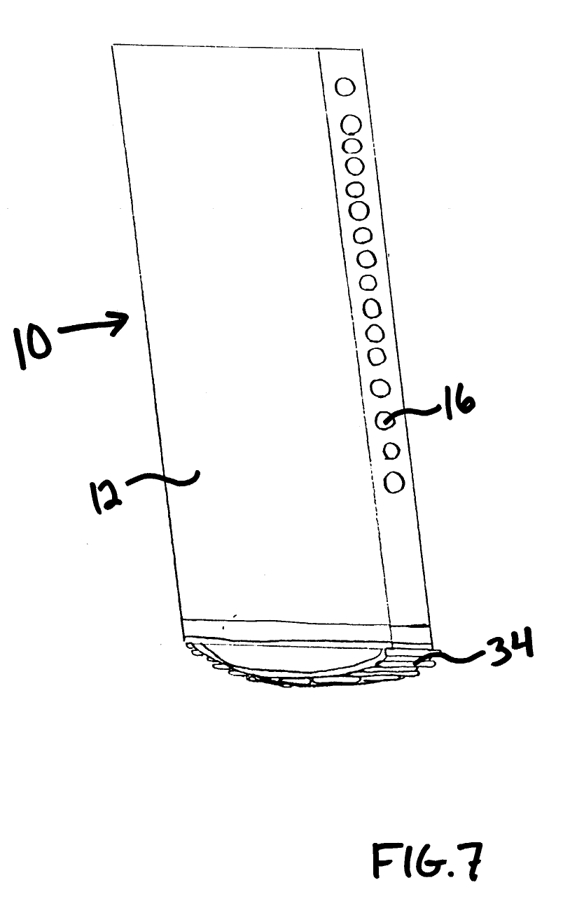

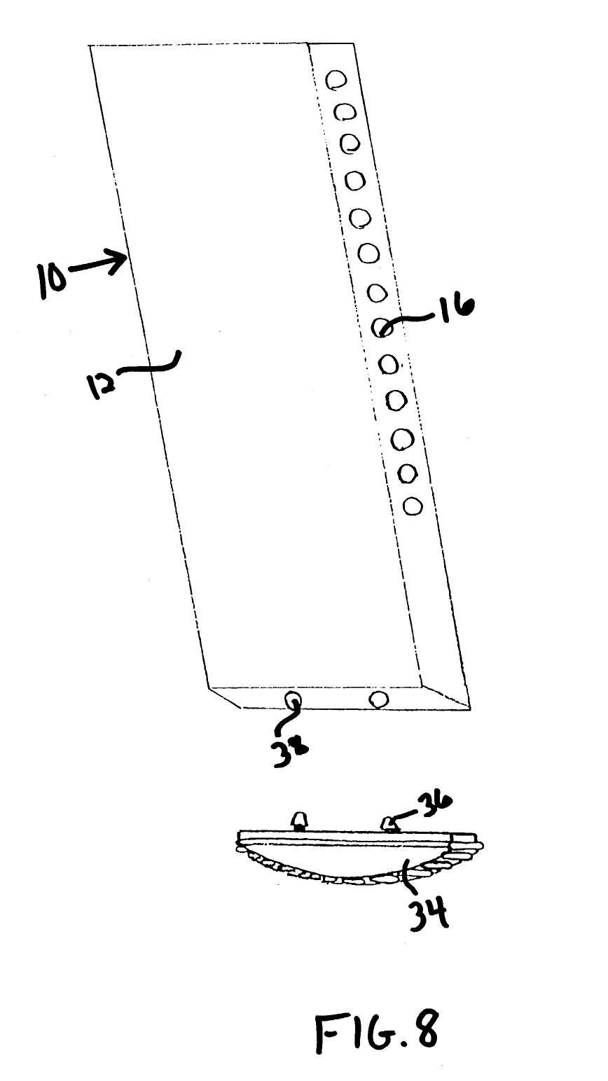

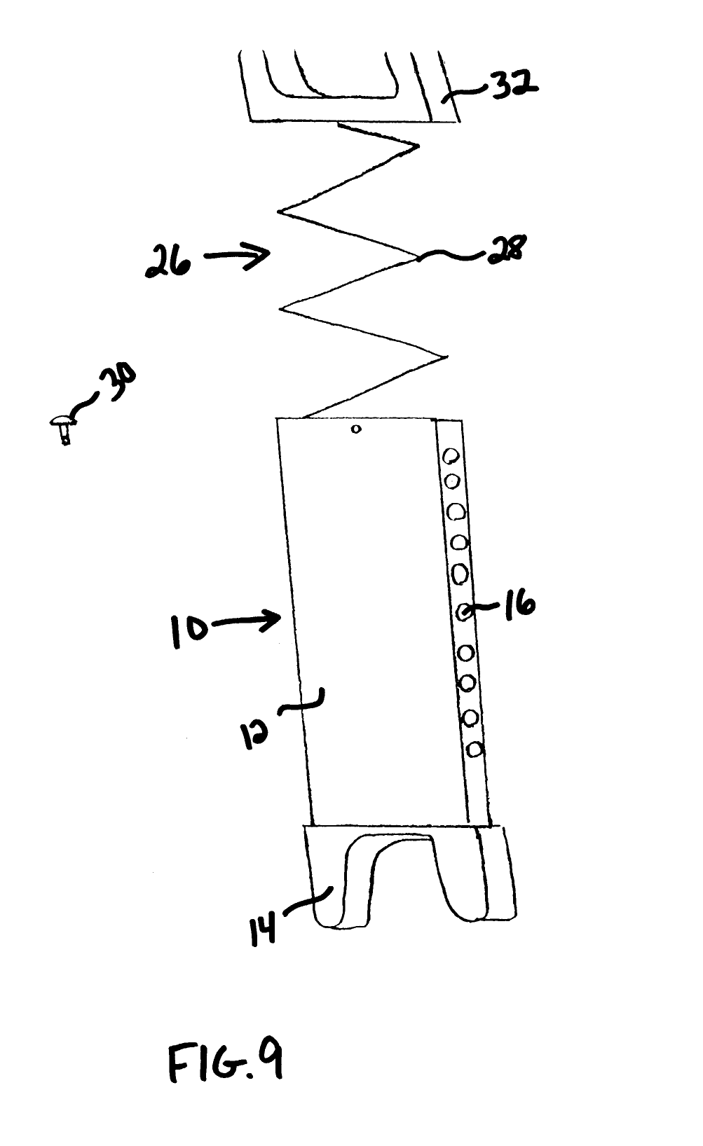

FIGS. 1-4 show different views of one embodiment of the ladder leveler device. This particular embodiment is designed for use with stackable ladders, but could also be used as a stand-alone ladder. FIG. 1 shows the leveling leg 10. The leveling leg 10 has a shaft 12 and a ladder foot 14, which has a substantially U-shape as can be seen in FIG. 2. The U-shaped foot 14 permits the ladder to be placed on an other ladder in a stacked fashion. The shaft 12 has a plurality of holes 16 that are drilled or cut the entire way through the shaft 12 to the other side. The shaft 12 is preferably hollow, as can be seen in FIG. 3, but could also be solid in at least one possible embodiment of the present invention.

FIG. 5 shows the various parts of the ladder leveler 10 prior to installation in a ladder. The ladder shown in FIG. 5 is a stackable ladder. Thus, the ladder leveler 10 has a foot 14 which matches the foot 14 of the other rail of the ladder. The end of the rail into which the leveler 10 is to be inserted has a hole 19. A quick release pin or locking pin 18 is also shown. After the ladder leveler 10 is inserted into the ladder rail, the locking pin 18 is inserted into the holes 16 and 19 and out the other side to lock the ladder leveler 10 into place. The pin 18 can be removed to permit movement of the ladder leveler 10 to a new position, and then reinserted to lock the ladder leveler 10 into the new position.

FIG. 6 shows one possible use of the ladder leveler 10, wherein the ladder is placed on a flight of stairs.

FIG. 7 illustrates a view of another possible embodiment of the ladder leveler 10. In this embodiment, a molded rubber grip foot 34 is attached to the bottom of the ladder leveler 10.

FIG. 8 illustrates the assembly of the embodiment shown in FIG. 7. The rubber grip foot 34 has rubber nibs 36, which are to be inserted into corresponding mounting holes 38 located on the bottom of the ladder leveler 10 to attach the rubber grip foot 34 to the ladder leveler 10.

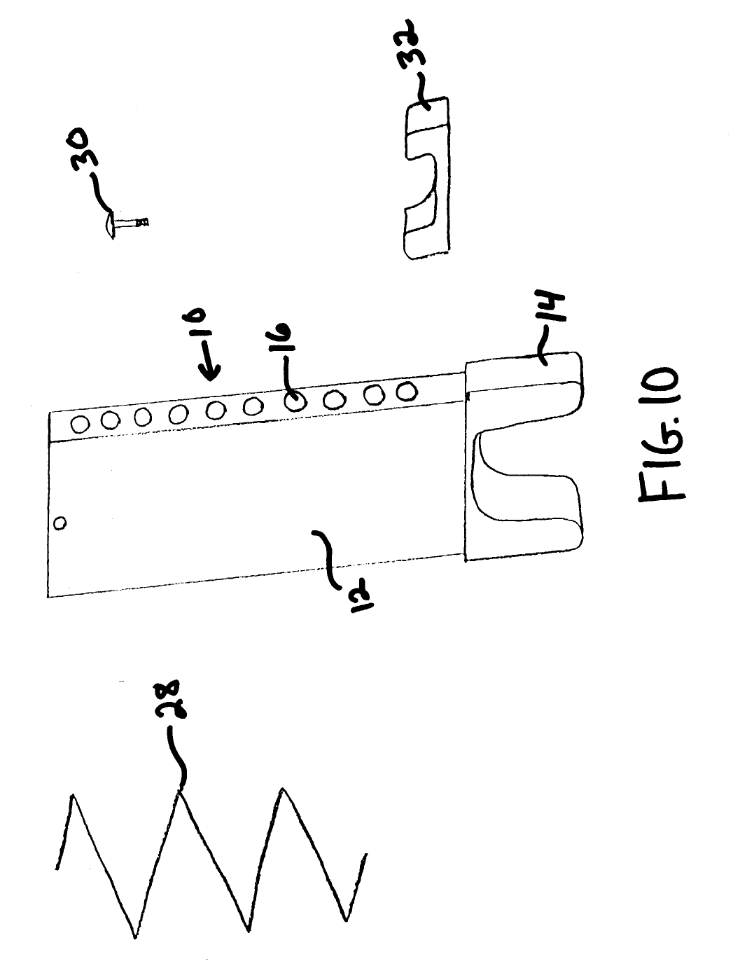

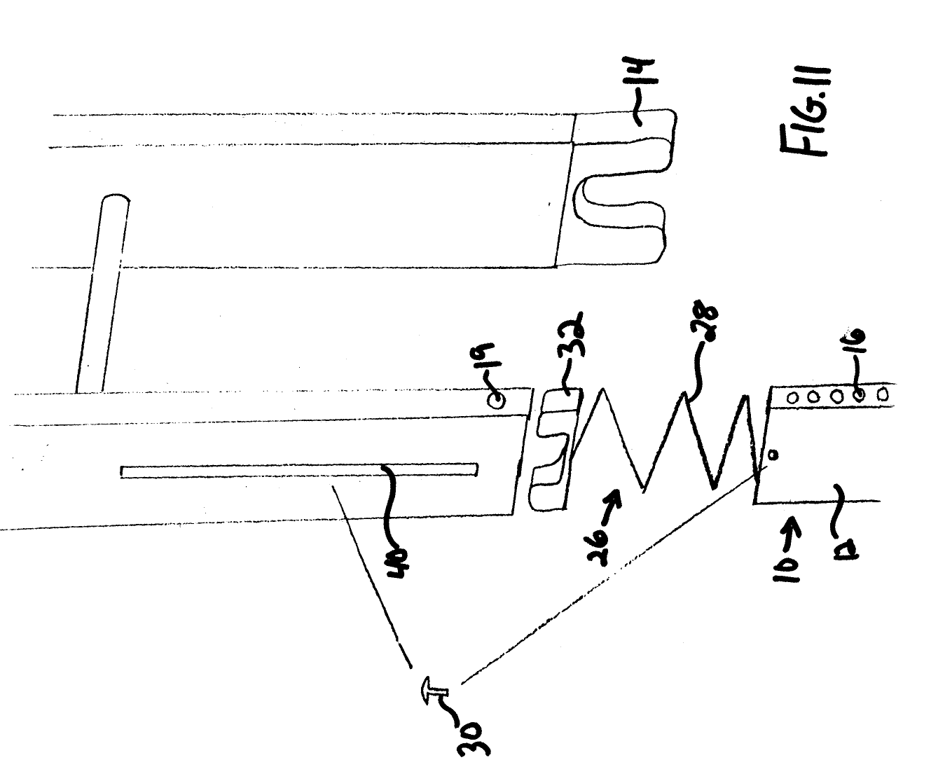

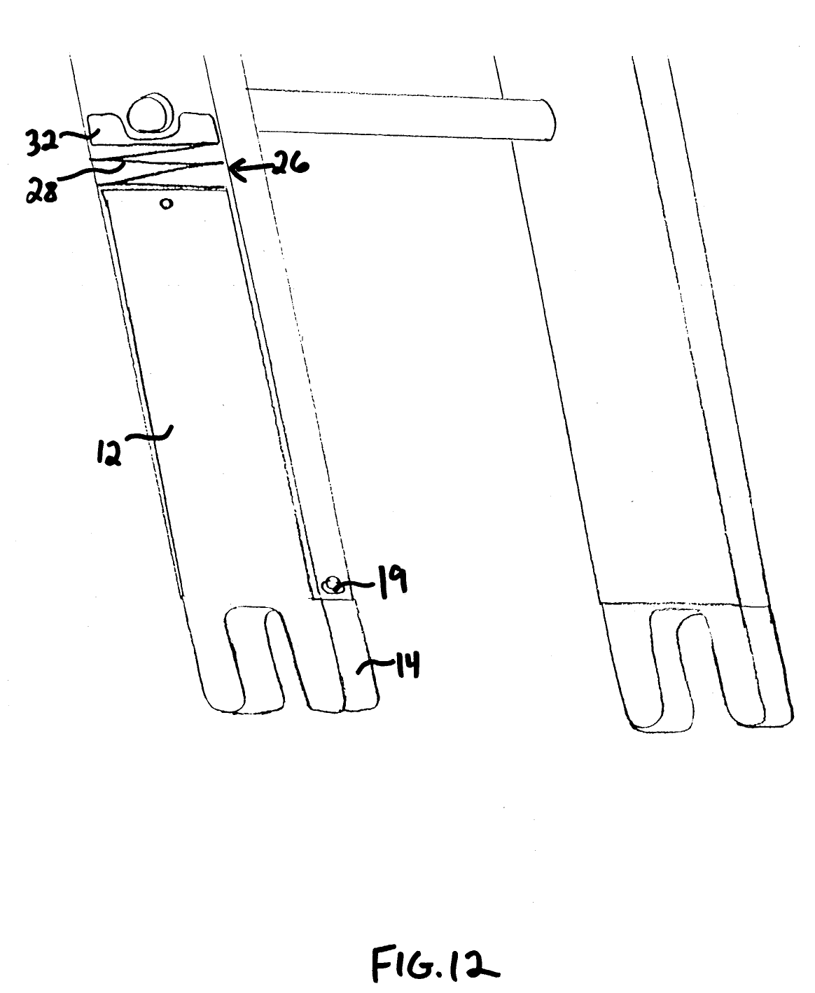

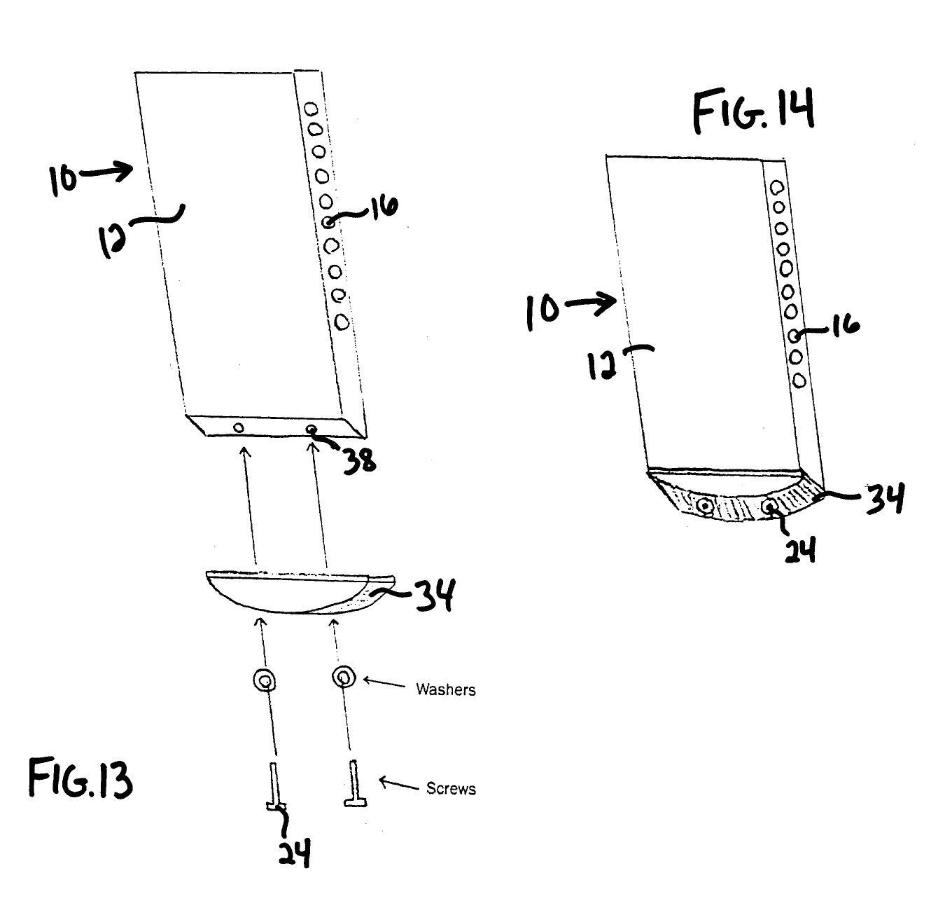

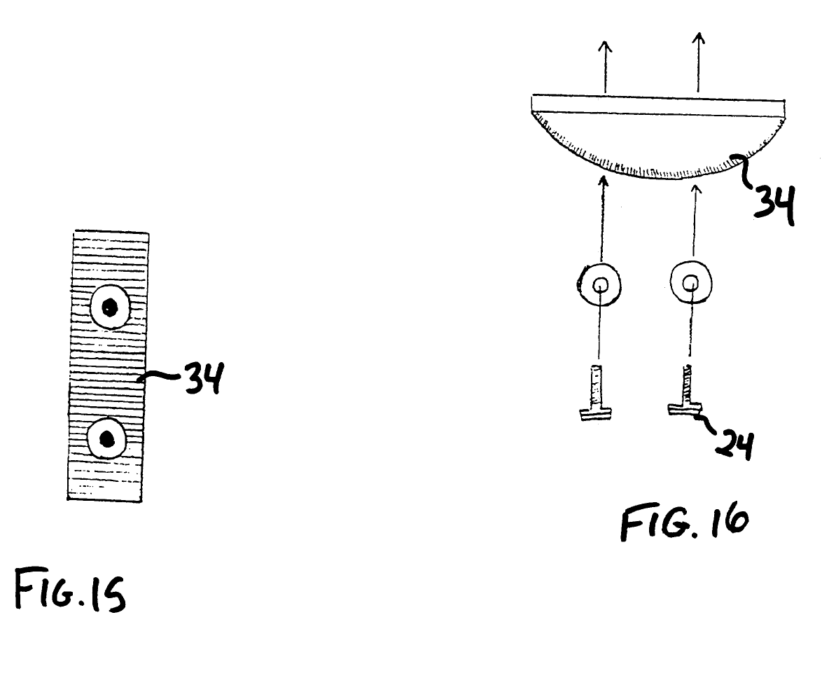

FIGS. 9-12 illustrate another possible embodiment of the invention discussed above which utilizes a spring-loaded mechanism 26. One end of a bandspring 28 is attached to the top of the leveler device 10 and the other is attached to the bottom side of a bandspring stop plate 32. The mechanism is inserted into the ladder rail until the bandspring stop plate 32 reaches and cradles the portion of a bottom ladder rung which extends inside the rail. The rung acts as a platform for spring compression. Once inside the rail, the device is secured with a guide stop pin 30, which is inserted into the hole in the top of the device through a channel 40 cut into the rail, as shown in FIG. 11. The bottom of the channel 40 acts as a catch for the guide stop pin 30, thereby preventing the device from falling out of the ladder rail. The spring-loaded design allows the device to automatically extend itself to the proper length without requiring the user to pull it down from an awkward position, or move the ladder to adjust it more easily.

FIGS. 13-16 show another embodiment of the invention in which the molded rubber grip foot 34 is attached to the leveler device 10 by screws 24. The screws 24 are inserted through holes in the rubber grip foot 34 and into threaded holes 38 in the bottom of the leveler device 10. Washers are placed between the heads of the screws 24 and the exterior of the rubber grip foot 34 to protect the rubber and ensure a tight fit.

FIGS. 17 and 18 show another embodiment of the leveler device 10. In this embodiment, an insert 20 is slid onto the leveler shaft 12. A retaining clip or flange 22 is then attached to the top surface of the leveler shaft 12. The leveler device 10 is then inserted into the ladder rail. The insert 20 is then pressed into the ladder rail to establish a friction fit such that the insert 20 is retained securely in the ladder rail. The locking pin 18 (not shown) is then inserted to lock the leveler device 10 into position as discussed above. The retaining clip 22 extends beyond the edges of the shaft 12. If the locking pin 18 is removed while the ladder is in a vertical position, the leveler device 10 can slide downward out of the ladder rail, but will not slide completely out as the extending portion of the retaining clip 22 will contact the insert 20 and be retained in the ladder rail.

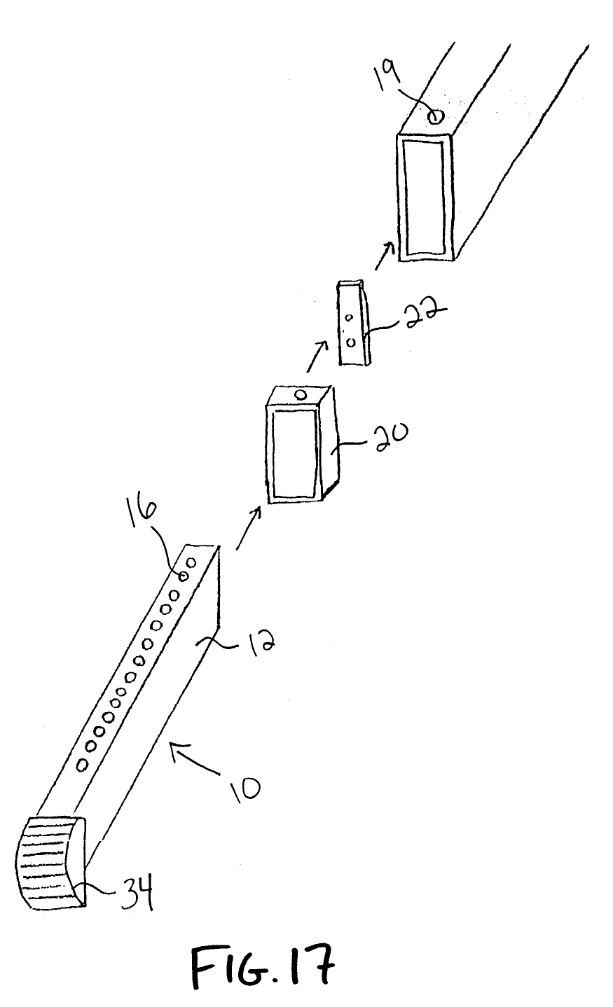

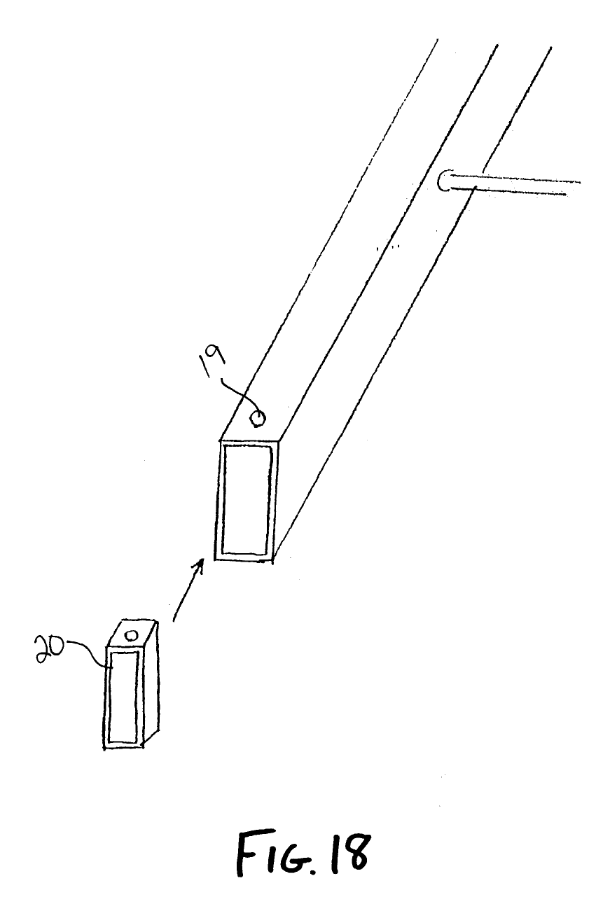

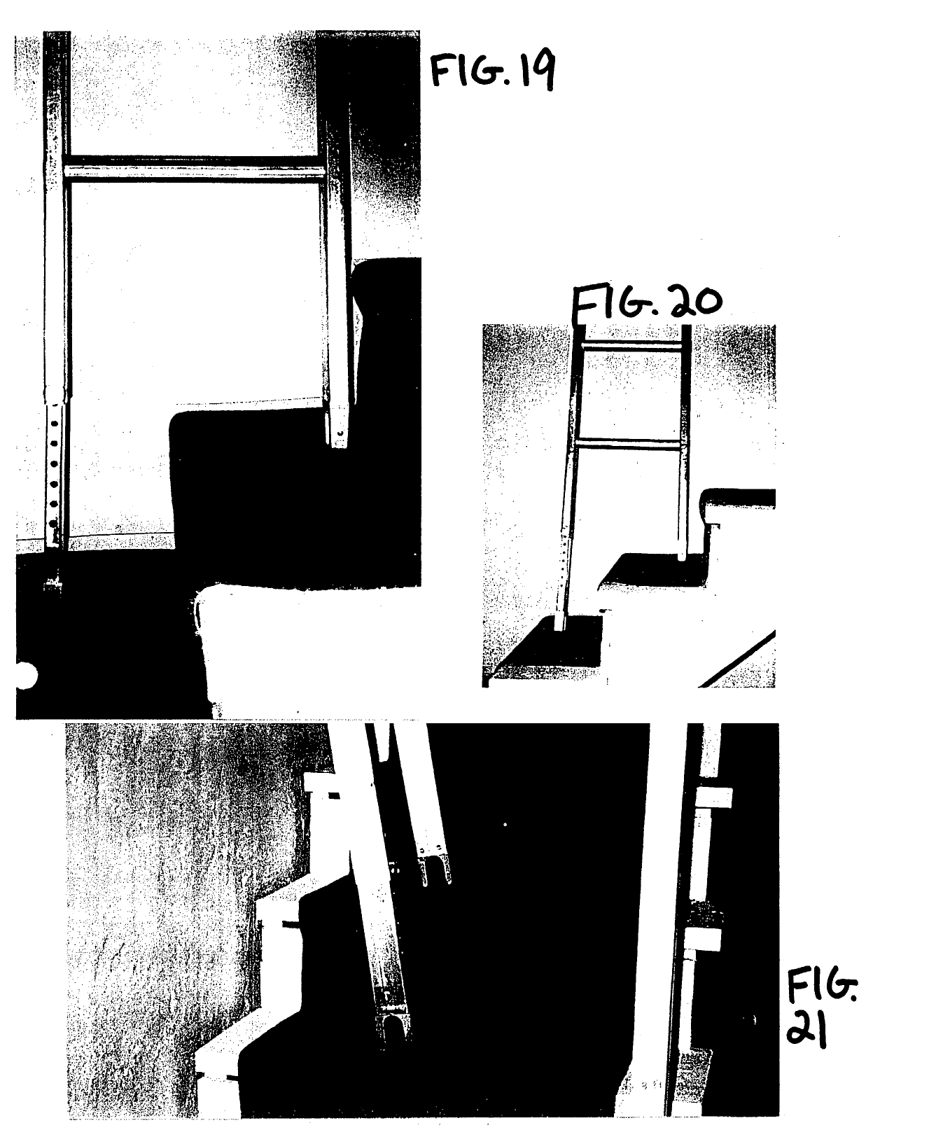

FIG. 19 shows a frontal view of the leveler device in use on a ladder that is standing on a flight of stairs. FIG. 20 shows a frontal view of the leveler device in use on a ladder that is standing on a flight of stairs. FIG. 21 shows a perspective view of the leveler device in use on a ladder that is standing on a flight of stairs.

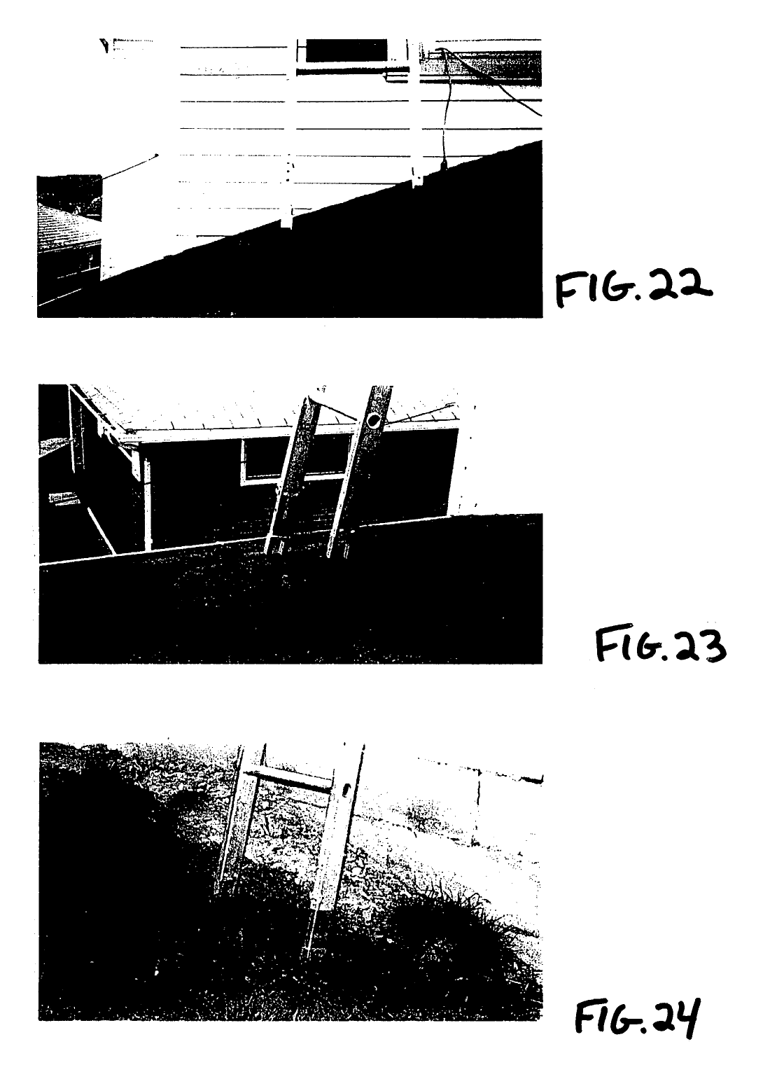

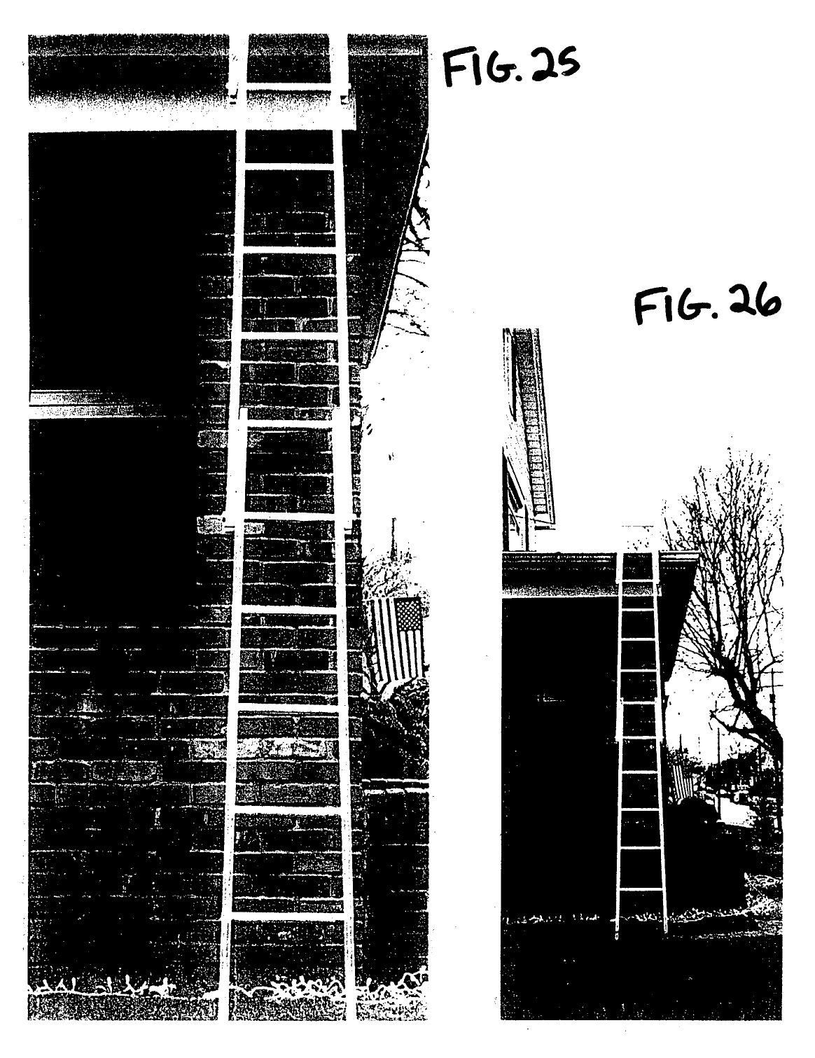

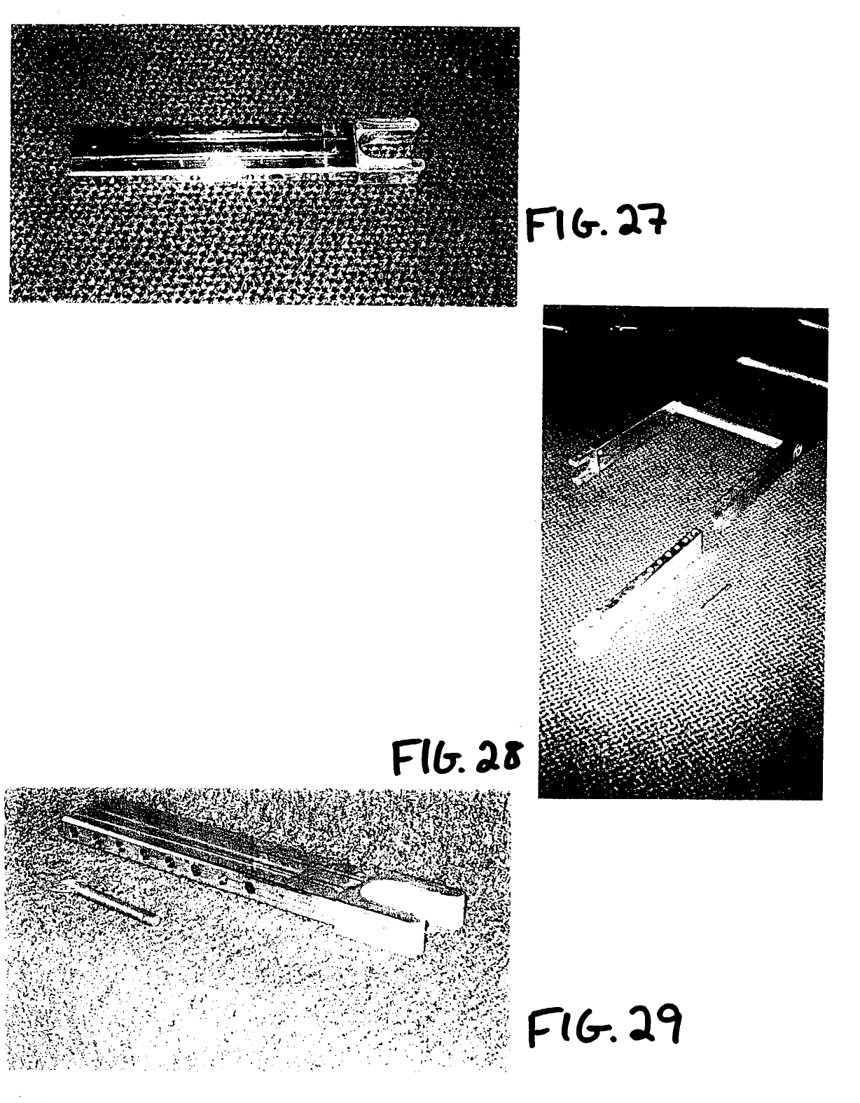

FIG. 22 is an example of the leveler device being used on the sloped surface of a roof. FIG. 23 shows a good representation of how the quick release pin is inserted into the ladder rail passing through the leveler device itself, and can be seen protruding from out of the back side of ladder rail. FIG. 24 shows the leveler device being applied for use on uneven or sloped ground.

FIG. 25 shows the leveler device's concealment and simplistic design, giving it the ability to be used as a stackable section of assembled ladders. It can be seen on the lower left rail of the section that is between the upper and lower sections of the ladder. FIG. 26 is similar to FIG. 25, except the photo is taken at a further distance.

FIG. 27 shows the leveler device lying flat on the ground. FIG. 28 shows the leveler device disassembled and laying next to the ladder rail from which it has been removed. Also shown laying to the right of the leveler device is the quick release pin that is used to lock the leveler device into place for adjustment. FIG. 29 shows the leveler device and the quick release pin lying flat on the ground.

To further explain, the device described herein is a ladder leveler. It is a device used to keep ladders vertically stable on uneven surfaces. The actual device is of one-piece construction and made of metal alloy. The square shaft of part is sized to fit inside the rail of the ladder allowing it to move within the rail for adjustment. Adjustment can then be locked into place by means of inserting a quick release pin. The quick release pin is introduced through a hole in the ladder rail, which then allows the pin to pass through the part itself out through a hole on the other side of rail enabling it to be locked into place. The bottom of the device or foot of the ladder is shaped so that it may incorporate all of the ladders previous functions, which include the ability for the ladder section to be used in the ladders ability to be stacked one on top of the other. The square shaft of the device has holes drilled through the side of the square shaft that line up with the hole drilled in the rail of the ladder that allow locking adjustment. The foot of the device imitates the actual shape and size of the original ladder feet, which allow it to be used as a functioning stackable middle section. The design is an improvement over other levelers in its simplicity and concealment, which makes it virtually out of sight and leaves no hindrances for user to inadvertently catch self or clothing on a bulky apparatus. This ladder leveler is not designed for use with the standard or average extension ladder. It is for use with certain stackable or sectional type ladders and can be adjusted through minor size and parameter changes to fit within different sizes of similar types of ladders made by various different manufacturers. The foot of the device can also be made as to imitate different types of feet or pads on the ladder for use on different surfaces.

Another possible embodiment has a Spring-Loaded portion of the device. It consists of 3 separate parts that are attached to the device. These parts are as follows: 1. Bandspring. 2. Guide Stop Pin and 3. Bandspring Stop Plate. The spring-loaded mechanism is assembled by attaching one end of bandspring to the top of the device and the other end of the bandspring to the bottom side of the Bandspring Stop Plate. These assembled parts are then inserted into the ladder rail until the Bandspring Stop Plate has reached it's position where it meets the portion of the bottom ladder rung that extends inside the rail. When the Bandspring Stop Plate reaches the rung it will be cradling the rung preventing the bandspring from traveling beyond the lower rung and will provide a platform for compression on the spring. The next step will be to insert and mount the Guide Stop Pin into the hole in the top of the device. This can be done by way of a channel that is cut into the side of the ladder rail. The bottom of this channel will act as a stop for the Guide Stop Pin to seat into preventing the device form exiting the ladder rail. Once inserted and compressed to its closed position, a Detent Ring Pin is used to keep it in place. The reason for the spring-loaded part of the device is to allow the leveler to automatically extend itself into positioning for adjustment and use.

In another possible embodiment of the present invention the leveler has a molded rubber grip attached to the bottom of it for use on surfaces to which a better grip is called for. Some examples of these surfaces would include such things as smooth tile or concrete. This version of the device is inserted into the ladder rail the same as the other versions are inserted. The same Detent Ring Pin that is used to adjust and secure the other versions of the leveler is also used in this version in the same manner. There are two different versions of attachments shown in the drawings provided, one of which is shown mounted by means of two screws and two washers. These are tightened down into two recessed holes in the rubber bottom and into two threaded holes tapped into the bottom of the device itself. The other version of rubber bottom is attached to device by way of two rubber nibs on the backside of the rubber bottom. These rubber nibs are then pressed into the bottom of the device into two holes provided for them.

The components disclosed in the various publications, disclosed or incorporated by reference herein, may be used in the embodiments of the present invention, as well as equivalents thereof.

The appended drawings in their entirety, including all dimensions, proportions and/or shapes in at least one embodiment of the invention, are accurate and are hereby included by reference into this specification.

One feature of the invention resides broadly in a stackable ladder comprising: two rails comprising a first rail and a second rail; a plurality of parallel rungs being configured and disposed to connect said two rails; at least one of said rungs being configured and disposed to extend out of said two rails to permit stacking of another stackable ladder; said two rails being angled inward toward one another to permit stacking of another stackable ladder; a leveling device being inserted into said first rail and being configured to be moved to extend from said first rail to permit adjustment of the length of said first rail to compensate for uneven surfaces on which the ladder is to be placed; said leveling device comprising: a metal alloy shaft being configured and disposed to be displaced inside said rail for adjustment; and a foot portion shaped to permit stacking of said stackable ladder on another ladder and being attached to the bottom end of said shaft; said shaft comprising a plurality of holes cut through said shaft; said first rail comprising a hole cut through said first rail; a locking pin; and said locking pin being configured to be inserted through said hole in said first rail and one of said plurality of holes in said shaft to lock said shaft in a desired position.

All, or substantially all, of the components and methods of the various embodiments may be used with at least one embodiment or all of the embodiments, if more than one embodiment is described herein.

All of the patents, patent applications and publications recited herein, and in the Declaration attached hereto, are hereby incorporated by reference as if set forth in their entirety herein.

A further feature of the invention resides broadly in a ladder leveling kit for use in a ladder to permit adjustment of the length of at least one of the rails of the ladder to compensate for uneven surfaces on which the ladder is to be placed, said ladder leveling kit comprising: a shaft being configured to be inserted into the bottom of a rail of a ladder; a foot portion being attached to said shaft; said shaft comprising a plurality of holes cut through said shaft; a locking pin; and said locking pin being configured to be inserted through a hole in a rail of a ladder and one of said plurality of holes in said shaft to lock said shaft in a desired position.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The details in the patents, patent applications and publications may be considered to be incorporable, at applicant's option, into the claims during prosecution as further limitations in the claims to patentably distinguish any amended claims from any applied prior art.

Another feature of the invention resides broadly in a method of using a ladder leveling kit for use in a ladder to permit adjustment of the length of at least one of the rails of the ladder to compensate for uneven surfaces on which the ladder is to be placed, said ladder leveling kit comprising: a shaft being configured to be inserted into the bottom of a rail of a ladder; a foot portion being attached to said shaft; said shaft comprising a plurality of holes cut through said shaft; a locking pin; and said locking pin being configured to be inserted through a hole in a rail of a ladder and one of said plurality of holes in said shaft to lock said shaft in a desired position; said method comprising the steps of: inserting said shaft into a rail of a ladder until said shaft is extending from the rail a desired distance and a hole in the rail is aligned with one of said plurality of holes in said shaft; inserting said locking pin through a hole in the rail and said one of said plurality of holes in said shaft to lock said shaft in position; removing said locking pin after use of the ladder; moving said shaft in the rail of the ladder until said shaft is extending from the rail another desired distance and the hole in the rail is aligned with another one of said plurality of holes in said shaft; and reinserting said locking pin through the hole in the rail and said another one of said plurality of holes in said shaft to lock said shaft in position.

The abstract of the disclosure is submitted herewith as required by 37 C.F.R. §1.72(b). As stated in 37 C.F.R. §1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, the abstract is not intended to limit the claims in any manner and should not be interpreted as limiting the claims in any manner.

The invention as described hereinabove in the context of the preferred embodiments is not to be taken as limited to all of the provided details thereof, since modifications and variations thereof may be made without departing from the spirit and scope of the invention.

What is claimed is:

1. A stackable ladder comprising:
two rails comprising a first rail and a second rail;
a plurality of parallel rungs being configured and disposed to connect said two rails;
at least one of said rungs being configured and disposed to extend out of said two rails to permit stacking of another stackable ladder;
said two rails being angled inward toward one another to permit stacking of another stackable ladder;
a leveling device being inserted into said first rail and being configured to be moved to extend from said first rail to permit adjustment of the length of said first rail to compensate for uneven surfaces on which the ladder is to be placed;
said leveling device comprising:
a metal alloy shaft being configured and disposed to be displaced inside said rail for adjustment; and
a foot portion shaped to permit stacking of said stackable ladder on another ladder and being attached to the bottom end of said shaft;
said shaft comprising a plurality of holes cut through said shaft;
said first rail comprising a hole cut through said first rail;
a locking pin; and
said locking pin being configured to be inserted through said hole in said first rail and one of said plurality of holes in said shaft to lock said shaft in a desired position.

2. A ladder leveling kit for use in a ladder to permit adjustment of the length of at least one of the rails of the ladder to compensate for uneven surfaces on which the ladder is to be placed, said ladder leveling kit comprising:
a shaft being configured to be inserted into the bottom of a rail of a ladder;
a foot portion being attached to said shaft;
said shaft comprising a plurality of holes cut through said shaft;
a locking pin; and
said locking pin being configured to be inserted through a hole in a rail of a ladder and one of said plurality of holes in said shaft to lock said shaft in a desired position.

3. A method of using a ladder leveling kit for use in a ladder to permit adjustment of the length of at least one of the rails of the ladder to compensate for uneven surfaces on which the ladder is to be placed, said ladder leveling kit comprising: a shaft being configured to be inserted into the bottom of a rail of a ladder; a foot portion being attached to said shaft; said shaft comprising a plurality of holes cut through said shaft; a locking pin; and said locking pin being configured to be inserted through a hole in a rail of a ladder and one of said plurality of holes in said shaft to lock said shaft in a desired position; said method comprising the steps of:
inserting said shaft into a rail of a ladder until said shaft is extending from the rail a desired distance and a hole in the rail is aligned with one of said plurality of holes in said shaft;
inserting said locking pin through a hole in the rail and said one of said plurality of holes in said shaft to lock said shaft in position;
removing said locking pin after use of the ladder;
moving said shaft in the rail of the ladder until said shaft is extending from the rail another desired distance and the hole in the rail is aligned with another one of said plurality of holes in said shaft; and
reinserting said locking pin through the hole in the rail and said another one of said plurality of holes in said shaft to lock said shaft in position.
